(19) United States
(12) Patent Application Publication
(10) Pub. No.: US 2021/0143405 A1
(43) Pub. Date: May 13, 2021

(54) MANUFACTURING METHOD OF NEGATIVE ELECTRODE MATERIAL FOR SECONDARY BATTERY

(71) Applicant: GET Green Energy Corp., Ltd., Taichung City (TW)

(72) Inventors: Wei-Jen Liu, Taoyuan City (TW); Cheng-Che Hsieh, New Taipei City (TW); Shin-Lee Liu, Pingtung County (TW); Jiann-Yih Yeh, Changhua County (TW); Pin-Han Wang, Taoyuan City (TW)

(73) Assignee: GET Green Energy Corp., Ltd., Taichung City (TW)

(21) Appl. No.: 16/746,935

(22) Filed: Jan. 19, 2020

(30) Foreign Application Priority Data
Nov. 13, 2019 (TW) 108141207

(51) Int. Cl. H01M 4/36; H01M 4/587; H01M 4/38; H01M 10/0525

(52) U.S. Cl. CPC H01M 4/364; H01M 4/587; H01M 2004/027; H01M 10/0525; H01M 4/386

(57) ABSTRACT

The invention provides a manufacturing method of a negative electrode material for a secondary battery. The manufacturing method includes following steps. A silicon-containing material is provided. The alkaline treatment is performed on the silicon containing material by placing the silicon containing material into an alkaline solution to obtain a modified silicon material. A peak intensity of the silicon-containing material at 3600 cm⁻¹ to 3000 cm⁻¹ in the spectrum by Fourier transform infrared spectroscopy (FTIR) is I₀, and a peak intensity of the modified silicon material at 3600 cm⁻¹ to 3000 cm⁻¹ in the spectrum by FTIR is I₁, wherein 0.9<I₀/I₁<1.

### CROSS-REFERENCE TO RELATED APPLICATION

This application claims the priority benefit of Taiwan application serial no. 108141207, filed on Nov. 13, 2019. The entirety of the above-mentioned patent application is hereby incorporated by reference herein and made a part of this specification.

### BACKGROUND OF THE INVENTION

### 1. Field of the Invention

The invention relates to a manufacturing method of a negative electrode material, and particularly relates to a manufacturing method of a negative electrode material for a secondary battery.

### 2. Description of Related Art

With the rising of the electric vehicle industry and the upgrading of the 3C industry, in addition to the consideration of charging speed of the battery, the capacity of the battery has been receiving more and more attention. For example, in response to the rising of the electric vehicle industry, the negative electrode material of the hard carbon with amorphous structure has been developed so that the lithium ion can have higher mass transfer rate to provide better fast-charge characteristic. However, the structural defects of the negative electrode material of the hard carbon may result to the disadvantages of poor capacity (e.g., less than 280 mAh/g), high irreversible capacity (e.g., 20% of the overall capacity), and the like. Therefore, how to develop a negative electrode material that can make a secondary battery to have good fast-charging/discharging capability, low irreversible capacity, high capacity, and high cycle stability, has become one of the goals for researchers to achieve.

### SUMMARY OF THE INVENTION

The invention provides a manufacturing method of a negative electrode material for a secondary battery that can make the secondary battery to have good fast-charging/discharging capability, low irreversible capacity, high capacity, and high cycle stability.

The invention provides a manufacturing method of a negative electrode material for a secondary battery. The method includes following steps. A silicon-containing material is provided. The alkaline treatment is performed on the silicon containing material by placing the silicon-containing material into an alkaline solution to obtain a modified silicon material. A peak intensity of the silicon-containing material at 3600 cm⁻¹ to 3000 cm⁻¹ in the spectrum by Fourier transform infrared spectroscopy (FTIR) is I₀, and a peak intensity of the modified silicon material at 3600 cm⁻¹ to 3000 cm⁻¹ in the spectrum by FTIR is I₁, wherein 0.9<I₀/I₁<1.

According to an embodiment of the invention, in the manufacturing method of the negative electrode material for the secondary battery, the alkaline solution includes at least one of NaOH, KOH, and NH₄OH.

According to an embodiment of the invention, in the manufacturing method of the negative electrode material for the secondary battery, the temperature of the alkaline solution is between 20° C. and 100° C.

According to an embodiment of the invention, in the manufacturing method of the negative electrode material for the secondary battery, the concentration of the alkaline solution is equal to or larger than 0.0001 M and less than 1 M.

According to an embodiment of the invention, in the manufacturing method of the negative electrode material for the secondary battery, the solid content of the silicon-containing material in the alkaline solution is between 1 wt % and 20 wt %.

According to an embodiment of the invention, in the manufacturing method of the negative electrode material for the secondary battery, the solid content of the silicon-containing material in the alkaline solution is between 5 wt % to 10 wt %.

According to an embodiment of the invention, in the manufacturing method of the negative electrode material for the secondary battery, the treatment time of the alkaline treatment is between 10 minutes and 60 minutes.

According to an embodiment of the invention, in the manufacturing method of the negative electrode material for the secondary battery, the crystal size of the modified silicon material is less than that of the silicon-containing material.

According to an embodiment of the invention, in the manufacturing method of the negative electrode material for the secondary battery, the bonding strength of a surface functional group of the modified silicon material is smaller than that of a surface functional group of the silicon-containing material.

According to an embodiment of the invention, the manufacturing method of the negative electrode material for the secondary battery further includes step: mixing the modified silicon material with a carbon-containing material, and performing a carbonization process to fabricate a modified carbon-silicon composite material.

Based on the above, in the manufacturing method of the negative electrode material for the secondary battery according to the embodiments of the invention, the crystallinity of silicon can be reduced by performing the alkaline treatment on the silicon-containing material, so that the modified silicon material for the negative electrode material may have good charging-discharging characteristic and stable structure. As such, when the modified silicon material is applied to the negative electrode for the secondary battery, the secondary battery may have good fast-charging/discharging capability, low irreversible capacity, high capacity, and high cycle stability. On the other hand, it is easy to obtain the source of the alkaline solution used in the alkaline treatment, and the process of the alkaline treatment can be performed merely under the normal pressure. As such, the negative electrode material for the secondary battery may have the advantages of short production cycle and low manufacturing cost.

In addition, the peak intensity of the silicon-containing material at 3600 cm⁻¹ to 3000 cm⁻¹ in the spectrum by Fourier transform infrared spectroscopy (FTIR) is I₀, and the peak intensity of the modified silicon material at 3600 cm⁻¹ to 3000 cm⁻¹in the spectrum by FTIR is I₁, wherein 0.9<I₀/I₁<1. That indicates the ratio of the peak intensity in OH stretching of the silicon-containing material at the surface thereof and the peak intensity in OH stretching of the modified silicon material at the surface thereof is between 0.9 and 1. That is, the above alkaline treatment may avoid the undesired side reactions so as to have good process yield and stability.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart of the manufacturing method of the negative electrode material for the secondary battery according to an embodiment of the invention.

FIG. 2 is a FTIR spectrum after the alkaline treatment is performed on the silicon-containing material in different concentrations of the alkaline solutions.

FIG. 3 is a FTIR spectrum after the alkaline treatment is performed on the silicon-containing material in different kinds of the alkaline solutions.

FIG. 4 is a FTIR spectrum after the alkaline treatment is performed on the silicon-containing material with different solid content in the alkaline solutions.

FIG. 5 is a FTIR spectrum after the alkaline treatment is performed on the silicon-containing material with different alkaline treatment time in the alkaline solutions.

FIG. 6A is a Brunauer-Emmett-Teller (BET) diagram after the alkaline treatment is performed on the silicon-containing material in different kinds of the alkaline solutions.

FIG. 6B is a Barrett-Joyner-Halenda (BJH) diagram after the alkaline treatment is performed on the silicon-containing material in different kinds of the alkaline solutions.

FIG. 7 is a diagram illustrated cycle life test of Embodiment 1 and Reference Embodiment 1.

FIGS. 8A and 8B are diagrams respectively illustrated charging-discharging per 10 cycles of Reference Embodiment 1 and Embodiment 1.

### DESCRIPTION OF THE EMBODIMENTS

In the following, the invention will be more thoroughly described with reference to the drawings of the embodiments. However, the invention may also be implemented in various forms, and shall not be construed as being limited to the embodiments described herein. In the drawings, the thicknesses of layers and regions are increased for clearer illustration. Like or similar reference symbols represent like or similar components, and the descriptions thereof will not be repeated. In the following embodiments, wordings used to indicate directions, such as “up,” “down,” “left”, “right”, “front”, “rear”, etc., merely refer to directions in the accompanying drawings. Thus, the language used to describe the directions is not intended to limit the scope of the invention.

It will be understood that when an element is referred to as being “on” or “connected” to another element, it may be directly on or connected to the other element, or the intervening elements may be presented. If an element is referred to as being “directly on” or “directly connected” to another element, the intervening elements are not presented.

As used herein, “about”, “approximately” or “substantially” includes the values as mentioned and the average values within the range of acceptable deviations that can be determined by those skill in the art. Considering to the specific amount of errors related to the measurements (i.e., the limitations of the measurement system), the meaning of “about” may be, for example, referred to a value within one or more standard deviations of the value. Furthermore, the “about”, “approximate” or “substantially” used herein may be based on the optical property, etching property or other properties to select a more acceptable deviation range or standard deviation, but may not apply one standard deviation to all properties.

The terms used herein are merely used to describe exemplary embodiments and are not used to limit the invention. In this case, unless indicated in the context specifically, otherwise the singular forms include the plural forms.

FIG. 1 is a flowchart of the manufacturing method of the negative electrode material for the secondary battery according to an embodiment of the invention.

Referring to FIG. 1, a step S100 is performed to provide a silicon-containing material. In the embodiment, the silicon-containing material may be, for example, silicon, silicon oxide, silicon carbide, silicon-carbon compound, and the like.

Then, a step S102 is performed to obtain a modified silicon material by performing an alkaline treatment on the silicon-containing material through placing the silicon-containing material into the alkaline solution. Thereby, the modified silicon material for the negative electrode material may have good charging-discharging characteristic and stable structure. As such, when the modified silicon material is applied to the negative electrode for the secondary battery, the secondary battery may have good fast-charging/discharging capability, low irreversible capacity, high capacity, and high cycle stability.

On the other hand, it is easy to obtain the source of the alkaline solution used in the above alkaline treatment, and the process of the alkaline treatment can be performed merely under the normal pressure. Compared to the fabrication of smaller-sized silicon particles by ball milling or the fabrication of the silicon-carbon composite with core-shell structure by hydrofluoric acid (HF), the alkaline treatment does not require expensive equipment, and the cost of the material used in the alkaline treatment is lower than that of the aforementioned fabrications.

In the embodiment, although the use of the silicon-containing material as the negative electrode material for the secondary battery can make the secondary electrode have characteristic of high capacity, the volume of the silicon-containing material may be dramatically expanded/shrunk while charging/discharging. As such, the particles may be smashed and thereby reduce the battery life. The above alkaline treatment of the invention can etch silicon to reduce the crystallinity of the silicon-containing material, thereby increasing the possibility of lithium ions migrating to the negative electrode and achieving better structural stability.

In the embodiment, A peak intensity of the silicon-containing material at 3600 cm⁻¹ to 3000 cm⁻¹in the spectrum by Fourier transform infrared spectroscopy (FTIR) is Jo, and a peak intensity of the modified silicon material at 3600 cm⁻¹ to 3000 cm⁻¹in the spectrum by FTIR is Ii, wherein 0.9<I₀/I₁<1. That indicates the ratio of the peak intensity in OH stretching of the silicon-containing material at the surface thereof and the peak intensity in OH stretching of the modified silicon material at the surface thereof is ranging from 0.9 to 1. That is, the above alkaline treatment may avoid the undesired side reactions so as to have good process yield and stability.

In the embodiment, the alkaline solution may include at least one of NaOH, KOH, and NH₄OH. In the embodiment, the temperature of the alkaline solution may be ranging from 20° C. to 100° C. In the embodiment, the concentration of the alkaline solution is equal to or larger than 0.0001 M and less than 1 M. In the embodiment, the treatment time of the alkaline treatment may be ranging from 10 minutes to 1440 minutes, and more preferably from 10 minutes to 60 minutes, so as to achieve a shorter production cycle. In the embodiment, the concentration of the alkaline solution can be adjusted according to the temperature and the treatment time of the alkaline solution, as long as the silicon can be etched and the undesired side reactions can be avoided, that is to satisfy the relation 0.9<I₀/I₁<1. In the embodiment, the solid content of the silicon-containing material in the alkaline solution may be ranging from 1 wt % to 20 wt %, and more preferably from 5 wt % to 10 wt %.

In the embodiment, the crystal size of the modified silicon material may be less than that of the silicon-containing material. In the embodiment, the bonding strength of a surface functional group of the modified silicon material may be smaller than that of a surface function group of the silicon-containing material. For example, the absorption peak of the in-plane Si—O stretching is obvious in the FTIR spectrum of the silicon-containing material; and the absorption peak of the out-of-plane Si—O stretching is obvious in the FTIR spectrum of the modified silicon material.

Referring to FIG. 1 again, the manufacturing method of the negative electrode material for the secondary battery may further include performing a step S104 to mix the modified silicon material with a carbon-containing material and then performing a carbonization process (also refer to a carbon cladding process) to fabricate a modified carbon-silicon composite material. In the embodiment, the carbon-containing material may be, for example, glucose, sucrose, polymer, asphalt, and the like. The carbonization process may be, for Example, performed by using a p-toluenesulfonic acid or a sintering method, but the invention is not limited thereto. In the embodiment, the carbon-containing material may be cladded on the surface of the modified silicon material.

Based on the above, the manufacturing method of the negative electrode material for the secondary battery in the above embodiment may reduce the crystallinity of the silicon by performing the alkaline treatment on the silicon-containing material so as to improve the rate where the lithium ions migrate in and out of the structure. Thereby, the modified silicon material may be formed to have good fast-charging/discharging characteristic and stable structure after the alkaline treatment. Therefore, when the modified silicon material is applied to the negative electrode material for the secondary battery, the secondary battery will have good fast-charging/discharging capability, low irreversible capacity, high capacity and high cycle stability.

The features of the invention are more specifically described in the following with reference to the Examples 1-12, Comparative Examples 1-3, Reference Example 1, Reference Embodiment 1, and Embodiment 1. Although the following Examples and Embodiment are described, the materials used and the amount and ratio thereof, as well as handling details and handling process . . . etc., can be suitably modified without exceeding the scope of the invention. Accordingly, restrictive interpretation should not be made to the invention based on experimental example 1 described below.

### EXAMPLE 1

First, an alkaline solution containing 0.1 M NaOH was prepared in 100 g of DI water. Next, the above alkaline solution is heated to 70° C., and then 10 g of silicon powder is added to the alkaline solution and reacted for 30 minutes. After that, the alkaline solution is neutralized by HCl and then washed by DI water until the neutral state. Finally, the drying process was performed by placing the neutralized solution into the oven to obtain the modified silicon material.

### EXAMPLE 2

A modified silicon material was manufactured in the same manner as in the Example 1 except that the alkaline solution containing 0.1 M KOH was used instead of the alkaline solution containing 0.1 M NaOH.

### EXAMPLE 3

A modified silicon material was manufactured in the same manner as in the Example 1 except that the alkaline solution containing 0.1 M NH₄OH was used instead of the alkaline solution containing 0.1 M NaOH.

### EXAMPLE 4

A modified silicon material was manufactured in the same manner as in the Example 1 except that the alkaline solution containing 0.1 M NaOH and KOH was used instead of the alkaline solution containing 0.1 M NaOH.

### EXAMPLE 5

A modified silicon material was manufactured in the same manner as in the Example 1 except that the alkaline solution containing 0.1 M NaOH and NH₄OH was used instead of the alkaline solution containing 0.1 M NaOH.

### EXAMPLE 6

A modified silicon material was manufactured in the same manner as in the Example 1 except that the alkaline solution containing 0.1 M KOH and NH₄OH was used instead of the alkaline solution containing 0.1 M NaOH.

### EXAMPLE 7

A modified silicon material was manufactured in the same manner as in the Example 1 except that 1 g of silicon powder was used instead of 10 g of silicon powder.

### EXAMPLE 8

A modified silicon material was manufactured in the same manner as in the Example 1 except that 5 g of silicon powder was used instead of 10 g of silicon powder.

### EXAMPLE 9

A modified silicon material was manufactured in the same manner as in the Example 1 except that 20 g of silicon powder was used instead of 10 g of silicon powder.

### EXAMPLE 10

A modified silicon material was manufactured in the same manner as in the Example 1 except that 10 g of silicon powder is added to the alkaline solution and reacted for 10 minutes instead of 10 g of silicon powder is added to the alkaline solution and reacted for 30 minutes.

### EXAMPLE 11

A modified silicon material was manufactured in the same manner as in the Example 1 except that 10 g of silicon powder is added to the alkaline solution and reacted for 1 hour instead of 10 g of silicon powder is added to the alkaline solution and reacted for 30 minutes.

### EXAMPLE 12

A modified silicon material was manufactured in the same manner as in the Example 1 except that 10 g of silicon powder is added to the alkaline solution and reacted for 24 hours instead of 10 g of silicon powder is added to the alkaline solution and reacted for 30 minutes.

### Comparative Example 1

A modified silicon material was manufactured in the same manner as in the Example 1 except that the alkaline solution containing 0.25 M NaOH was used instead of the alkaline solution containing 0.1 M NaOH.

### Comparative Example 2

A modified silicon material was manufactured in the same manner as in the Example 1 except that the alkaline solution containing 0.5 M NaOH was used instead of the alkaline solution containing 0.1 M NaOH.

### Comparative Example 3

A modified silicon material was manufactured in the same manner as in the Example 1 except that the alkaline solution containing 1 M NaOH was used instead of the alkaline solution containing 0.1 M NaOH.

### Reference Example 1

The Reference Example 1 is the silicon powder without alkaline treatment.

The Examples 1-12, Comparative Examples 1-3, and Reference Example 1 are summarized in Table 1 below.

TABLE 1

| | | | | | The solid |
|---|---|---|---|---|---|
| | | | | | content of |
| | | | | | the silicon |
| | | | | | in the |
| | Temper- | | | Concen- | alkaline |
| | ature | Time | Alkaline | tration | solution |
| | (° C.) | (min) | solution | (M) | (wt %) |
| Example 1 | 70 | 30 | NaOH | 0.1 | 10 |
| Example 2 | 70 | 30 | KOH | 0.1 | 10 |
| Example 3 | 70 | 30 | NH₄OH | 0.1 | 10 |
| Example 4 | 70 | 30 | NaOH + KOH | 0.1 | 10 |
| Example 5 | 70 | 30 | NaOH + NH₄OH | 0.1 | 10 |
| Example 6 | 70 | 30 | KOH + NH₄OH | 0.1 | 10 |
| Example 7 | 70 | 30 | NaOH | 0.1 | 1 |
| Example 8 | 70 | 30 | NaOH | 0.1 | 5 |
| Example 9 | 70 | 30 | NaOH | 0.1 | 20 |
| Example 10 | 70 | 10 | NaOH | 0.1 | 10 |
| Example 11 | 70 | 60 | NaOH | 0.1 | 10 |
| Example 12 | 70 | 1440 | NaOH | 0.1 | 10 |
| Comparative | 70 | 30 | NaOH | 0.25 | 10 |
| Example 1 | | | | | |
| Comparative | 70 | 30 | NaOH | 0.5 | 10 |
| Example 2 | | | | | |
| Comparative | 70 | 30 | NaOH | 1 | 10 |
| Example 3 | | | | | |
| Reference | — | — | — | — | — |
| Example 1 | | | | | |

### Experiment 1

A FTIR analysis was performed on the Example 1, Comparative Examples 1-3, and Reference Example 1, and the experimental results are shown in FIG. 2. The FIG. 2 is a FTIR spectrum after the alkaline treatment is performed on the silicon-containing material in different concentrations of the alkaline solutions. As shown in FIG. 2, the Si—O bonding of the modified silicon material of the Example 1 and the Comparative Examples 1-3 are changed from symmetric state (please refer to the Si—O stretching (Sym.) in the diagram) to asymmetric state (please refer to the Si—O stretching (Asym.) in the diagram) as compared to the Reference Example 1. This indicates that the silicon at the surface of the modified silicon materials of the Example 1 and Comparative Examples 1-3 has a chemical reaction, and the higher of the concentration of the alkaline solution is, the more of Si—O bonds are generated. However, when the concentration of the alkaline solution is too high, all of the silicon will be completely reacted.

On the other hand, as compared to the Reference Example 1, the absorption peak of the OH stretching (please refer to the OH stretching in the diagram) is not obvious in the FTIR spectrum of the modified silicon material of the Example 1, and the absorption peak of the OH stretching is obvious in the FTIR spectrum of the modified silicon material of the Comparative Examples 1-3. From here, it can be seen that when the temperature of the alkaline solution is 70° C. and the reaction time is 30 minutes, the alkaline treatment using the alkaline solution containing 0.1M NaOH may avoid the undesired side reactions.

### Experiment 2

A FTIR analysis was performed on the Examples 1-3 and Reference Example 1, and the experimental results are shown in FIG. 3. FIG. 3 is a FTIR spectrum after the alkaline treatment is performed on the silicon-containing material in different kinds of the alkaline solutions. As shown in FIG. 3, the Si—O bonding of the modified silicon material of the Examples 1-3 are changed from symmetric state (please refer to the Si—O stretching (Sym.) in the diagram) to asymmetric state (please refer to the Si—O stretching (Asym.) in the diagram) as compared to the Reference Example 1. This indicates that the silicon at the surface of the modified silicon materials of the Examples 1-3 has a chemical reaction.

On the other hand, the absorption peak of the OH stretching (please refer to the OH stretching in the diagram) is not obvious in the FTIR spectrum of the modified silicon material of the Examples 1-3 as compared to the Reference Example 1. From here, it can be seen that when the temperature of the alkaline solution is 70° C. and the reaction time is 30 minutes, the alkaline treatment using the alkaline solution containing 0.1M NaOH, KOH, or NH₄OH may avoid the undesired side reactions.

### Experiment 3

A FTIR analysis was performed on the Examples 1 and 7-9 and Reference Example 1, and the experimental results are shown in FIG. 4. FIG. 4 is a FTIR spectrum after the alkaline treatment is performed on the silicon-containing material with different solid content in the alkaline solutions. As shown in FIG. 4, the absorption peak of the in-plane Si—O stretching is obvious in the FTIR spectrum of the Reference Example 1; the absorption peak of the out-of-plane Si—O stretching is obvious in the FTIR spectrum of the Examples 7-9; and the absorption peak of the in-plane or out-of-plane Si—O stretching is not obvious in the FTIR spectrum of the Example 1. From here, it can be seen that the bonding strength of the surface functional group of the Examples 1 and 7-9 is smaller than that of the surface functional group of the Reference Example 1.

On the other hand, as compared to the Reference Example 1, the absorption peak of the OH stretching (please refer to the OH stretching in the diagram) is obvious in the FTIR spectrum of the modified silicon material of the Example 7, and the absorption peak of the in-plane or out-of-plane Si—O stretching is not obvious in the FTIR spectrum of the Example 1. From here, it can be seen that the solid content of the silicon-containing material in the alkaline solution is preferably ranging from 5 wt % to 10 wt % when the temperature of the alkaline solution containing 0.1M NaOH is 70 ° C. and the reaction time is 30 minutes.

### Experiment 4

A FTIR analysis was performed on the Examples 1 and 10-12 and Reference Example 1, and the experimental results are shown in FIG. 5. FIG. 5 is a FTIR spectrum after the alkaline treatment is performed on the silicon-containing material with different alkaline treatment time in the alkaline solutions. As shown in FIG. 5, the absorption peak of the in-plane Si—O stretching is obvious in the FTIR spectrum of the Reference Example 1; the absorption peak of the out-of-plane Si—O stretching is obvious in the FTIR spectrum of the Examples 10-12; and the absorption peak of the in-plane or out-of-plane Si—O stretching is not obvious in the FTIR spectrum of the Example 1. From here, it can be seen that the bonding strength of the surface functional group of the Examples 1 and 10-12 is smaller than that of the surface functional group of the Reference Example 1.

### Experiment 5

An XRD analysis was performed on the Examples 1-6 and Reference Example 1, and the experimental results are summarized in Table 2. From Table 2, the crystal sizes of the Examples 1-6 are smaller than that of the Reference Example 1, and the alkaline treatment with NaOH has better etching effect (that is, the degree of crystalline damage may be stronger and the full width at half maximum and the crystal size may be affected significantly).

TABLE 2

| | The intensity of Si | | | crystal |
|---|---|---|---|---|
| | (100) (%) | 2θ | Δθ | size (Å) |
| Example 1 | 61 | 28.52 | 0.18 | 377 |
| Example 2 | 59 | 28.52 | 0.22 | 423 |
| Example 3 | 83 | 28.47 | 0.19 | 417 |
| Example 4 | 66 | 28.47 | 0.20 | 402 |
| Example 5 | 100 | 28.42 | 0.21 | 387 |
| Example 6 | 96 | 28.47 | 0.22 | 373 |
| Reference | 100 | 28.47 | 0.18 | 458 |
| Example 1 | | | | |

### Experiment 6

Analyses are performed on the Examples 1-3 and Reference Example 1 by using a specific surface area and porosity analyzer to obtain the BET diagram (FIG. 6A) and the BJH diagram (FIG. 6B), and the experimental results are summarized in Table 3. FIG. 6A is a BET diagram after the alkaline treatment is performed on the silicon-containing material in different kinds of the alkaline solutions, wherein the vertical axis is the adsorption volume (Va)/cm³ (STP) g⁻¹, and the horizontal axis is the relative pressure (P/P₀). FIG. 6B is a BJH diagram after the alkaline treatment is performed on the silicon-containing material in different kinds of the alkaline solutions, wherein the vertical axis is the pore volume (cm³/g)/cm³, and the horizontal axis is the pore diameter (nm).

TABLE 3

| | | specific surface |
|---|---|---|
| | pore volume (cm³/g) | area (m²/g) |
| Reference | 276.31 | 8.6295 |
| Example 1 | | |
| Example 1 | 721.49 | 25.273 |
| Example 2 | 410.05 | 15.754 |
| Example 3 | 385.69 | 11.437 |

From Table 3, it can be seen that the Examples 1-3 have larger pore volume and the specific surface area as compared to the Reference Example 1, especially in the alkaline treatment of Example 1 using the alkaline solution containing NaOH, the pore volume increases from 276.31 cm³/g to 721.49 cm³/g, and the specific surface area increases from 8.6295 m²/g to 25.273 m²/g.

<Cycle Life Test>

The Example 1 and Reference Example 1 were subjected to the carbon cladding process as described above as the negative electrode material of the lithium ion battery, and the negative electrode materials were assembled into the lithium-ion batteries represented by Embodiment 1 and Reference Embodiment 1, respectively. In the experiment, the contain of the carbon cladding is 15 wt % relative to the total weight of the silicon material. A cycle life test was performed on the lithium ion batteries of Embodiment 1 and Reference Embodiment 1, and the experimental results are shown in FIG. 7. FIG. 7 is a diagram illustrated cycle life test of Embodiment 1 and Reference Embodiment 1. As can be seen from FIG. 7, the life time of the Embodiment 1 may be increased to 4 times as compared to the Reference Example 1.

<Stability Test>

A stability test was performed on the lithium ion batteries represented by Reference Embodiment 1 and Embodiment 1 through charging-discharging process, and the experimental results are shown in FIGS. 8A and 8B, respectively. FIGS. 8A and 8B are diagrams respectively illustrated charging/discharging per 10 cycles of Reference Embodiment 1 and Embodiment 1. As can be seen from FIG. 8A and FIG. 8B, the distance between the charging and discharging plateau of the Embodiment 1 is relatively close and the charging-discharging curve does not change due to the cycle number increase. This indicates that the above-mentioned alkaline treatment can dramatically improve the polarization phenomenon of the battery, so that the stability of the battery can be dramatically enhanced.

In view of the foregoing, the manufacturing method of the negative electrode material for the secondary battery according to the above embodiments of the invention can reduce the crystallinity of silicon by performing the alkaline treatment on the silicon-containing material so as to enhance the stability of the structure. As such, the modified silicon material treated with alkaline may have good charging-discharging characteristic and stable structure. Therefore, when the modified silicon material is applied to the negative electrode for the secondary battery, the secondary battery may have good fast charging-discharging capability, low irreversible capacity, high capacity, and high cycle stability.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A manufacturing method of a negative electrode material for a secondary battery, comprising:
providing a silicon-containing material; and
performing an alkaline treatment on the silicon-containing material to obtain a modified silicon material, wherein the alkaline treatment is performed by placing the silicon-containing material into an alkaline solution, and
a peak intensity of the silicon-containing material at 3600 cm⁻¹ to 3000 cm⁻¹in the spectrum by Fourier transform infrared spectroscopy (FTIR) is I₀, and a peak intensity of the modified silicon material at 3600 cm⁻¹ to 3000 cm⁻¹in the spectrum by FTIR is I₁, wherein 0.9<I₀/I₁<1.

2. The manufacturing method as claimed in claim 1, wherein the alkaline solution comprises at least one of NaOH, KOH, and NH₄OH.

3. The manufacturing method as claimed in claim 1, wherein the temperature of the alkaline solution is between 20° C. and 100° C.

4. The manufacturing method as claimed in claim 1, wherein the concentration of the alkaline solution is equal to or larger than 0.0001 M and less than 1 M.

5. The manufacturing method as claimed in claim 1, wherein the solid content of the silicon-containing material in the alkaline solution is between 1 wt % and 20 wt %.

6. The manufacturing method as claimed in claim 5, wherein the solid content of the silicon-containing material in the alkaline solution is between 5 wt % and 10 wt %.

7. The manufacturing method as claimed in claim 1, wherein the time of the alkaline treatment is between 10 minutes and 60 minutes.

8. The manufacturing method as claimed in claim 1, wherein the crystal size of the modified silicon material is less than that of the silicon-containing material.

9. The manufacturing method as claimed in claim 1, wherein the bonding strength of a surface functional group of the modified silicon material is smaller than that of a surface functional group of the silicon-containing material.

10. The manufacturing method as claimed in claim 1, further comprising:
mixing the modified silicon material with a carbon-containing material and performing a carbonization process to fabricate a modified carbon-silicon composite material.
